(19) United States
(12) Patent Application Publication
(10) Pub. No.: US 2009/0070276 A1
(43) Pub. Date: Mar. 12, 2009

(54) SYSTEM AND METHOD FOR PRINT PROOFING FOR FEE-BASED DOCUMENT OUTPUT DEVICES

(76) Inventors: Marianne L. Kodimer, Huntington Beach, CA (US); Silvy J. Wilson, Rancho Santa Margarita, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/851,143

(22) Filed: Sep. 6, 2007

(51) Int. Cl. G06F 17/00

(52) U.S. Cl. 705/400

(57) ABSTRACT

The subject application is directed to a print proofing system and method for fee-based document output devices. Electronic document data is first received of a selected electronic document for which tangible output is desired. A user is prompted for input of proof output data representing an instruction to generate a single, tangible copy of the electronic document. Proof output instruction data is received representing a desired sample tangible output corresponding to the electronic document. Output is then commenced of the copy corresponding to the received electronic document. Proof acceptability data is received representing the acceptability of the single, tangible copy of the electronic document data. The receipt of proof output instruction data is then disabled upon receipt of proof acceptability data indicating disapproval of the single, tangible copy. Upon receipt of approval of the single copy, fee data is generated associated with the tangible output of the received electronic document.

### BACKGROUND OF THE INVENTION

The subject application is directed generally to securing proofs of tangible outputs of electronic documents. The application is particularly applicable in providing a single output copy for user review and approval, without charge, prior to processing of an order for multiple copies.

Electronic documents are used extensively for generating tangible outputs, such as printouts. Electronic documents are suitably generated with applications, such as word processors or graphic design programs. Electronic documents may be generated at a device itself having print capabilities. Alternatively, media such as CDs, DVDs, flash-ram, or any suitable non-volatile data storage allows users to transport electronic documents for output at another location.

More recently, shared document devices, such as fee-based document processing devices in public places or greeting card generating kiosks have become popular. Users may generate a document for which many output copies are desired. It is an impediment to users if they are forced to order, and pay for many copies, when they have not yet seen an actual output of a particular document, or an output of their document at a particular location or with particular settings, such as paper type, which have been selected.

### SUMMARY OF THE INVENTION

In accordance with one embodiment of the subject application, there is provided a system and method for securing proofs of tangible outputs of electronic documents.

Further, in accordance with one embodiment of the subject application, there is provided a system and method for generating a single output copy for user review and approval, without charge, prior to processing of an order for multiple copies.

Still further, in accordance with one embodiment of the subject application, there is provided a print proofing system for fee-based document output devices. The system comprises means adapted for receiving electronic document data representative of a selected electronic document for which a tangible output is desired and means adapted for prompting a user for input of proof output data representative of an instruction to generate a single, tangible output copy corresponding to received electronic document data. The system also comprises means adapted for receiving proof output instruction data representative of a desired sample tangible output corresponding to received electronic document data and means adapted for commencing output of a single, tangible copy corresponding to received electronic document data after receipt of a proof output instruction. The system further includes means adapted for receiving proof acceptability data representative of acceptability of the single, tangible copy and means adapted for disabling receipt of proof output instruction data in accordance received proof acceptability data corresponding to disapproval of the single, tangible copy. The system also includes fee generation means adapted for generating fee data associated with generation of tangible output corresponding to the electronic document data upon receipt of proof output acceptability data corresponding to approval of the single, tangible copy.

In one embodiment of the subject application, the system further comprises means adapted for receiving revised electronic document data after receipt of proof acceptability data corresponding to disapproval and means adapted for re-enabling receipt of proof output instruction data after receipt of revised electronic document data.

In another embodiment of the subject application, the system also comprises means adapted for generating an indicia corresponding to a proof output operation on the single, tangible output copy.

In a further embodiment of the subject application, the system also comprises means adapted for receiving count data corresponding to a number of desired tangible output copies associated with electronic document data and means adapted for commencing output of a number of tangible output copies in accordance with received count data. In a preferred embodiment, the fee generation means includes means adapted for generating fee data in accordance with received count data. In another preferred embodiment, the system also comprises means adapted for receiving payment data from the associated user, which payment data corresponds to generated fee data.

Still further, in accordance with one embodiment of the subject application, there is provided a print proofing method for fee-based document output devices in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a print proofing system for fee-based document output devices according to one embodiment of the subject application;

FIG. 2 is a block diagram illustrating device hardware for use in the print proofing system for fee-based document output devices according to one embodiment of the subject application;

FIG. 3 is a functional diagram illustrating the device for use in the print proofing system for fee-based document output devices according to one embodiment of the subject application;

FIG. 4 is a block diagram illustrating controller hardware for use in the print proofing system for fee-based document output devices according to one embodiment of the subject application;

FIG. 5 is a functional diagram illustrating the controller for use in the print proofing system for fee-based document output devices according to one embodiment of the subject application;

FIG. 6 is a flowchart illustrating a print proofing method for fee-based document output devices according to one embodiment of the subject application; and

FIG. 7 is a flowchart illustrating a print proofing method for fee-based document output devices according to one embodiment of the subject application.

### DETAILED DESCRIPTION OF THE PREFERRED EMBODIMENT

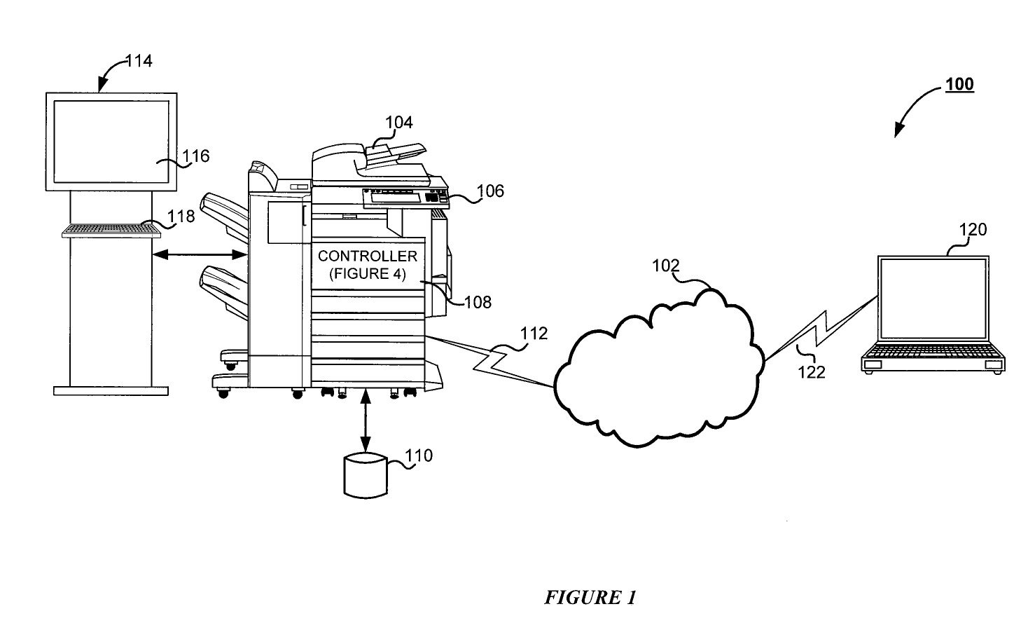

The subject application is directed to a system and method for securing proofs of tangible outputs of electronic documents. In particular, the subject application is directed to a system and method for generating a single output copy for user review and approval, without charge, prior to processing of an order for multiple copies. It will become apparent to those skilled in the art that the system and method described herein are suitably adapted to a plurality of varying electronic fields employing image previewing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a print proofing system 100 for fee-based document output devices in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

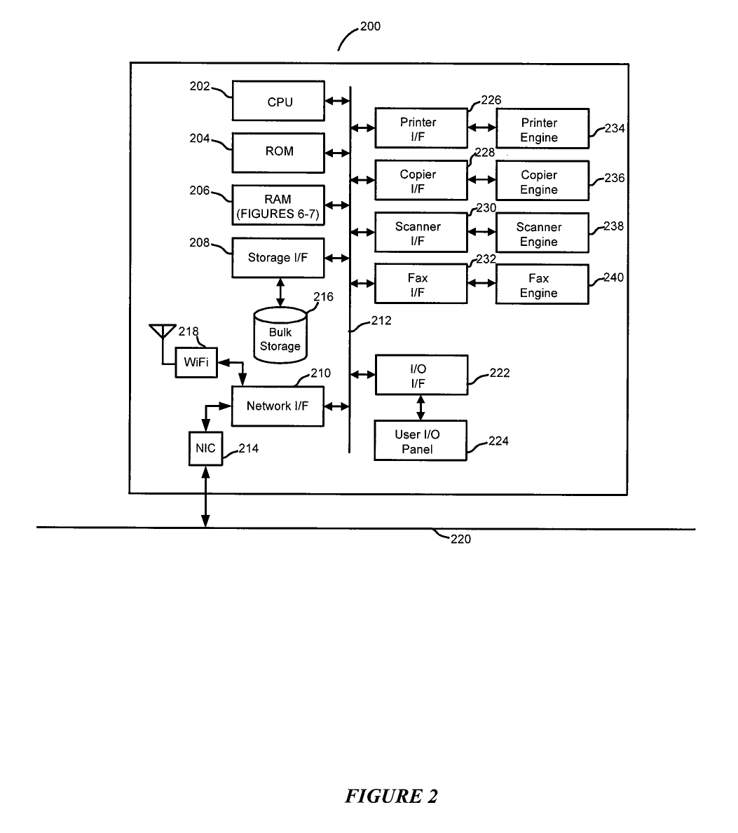

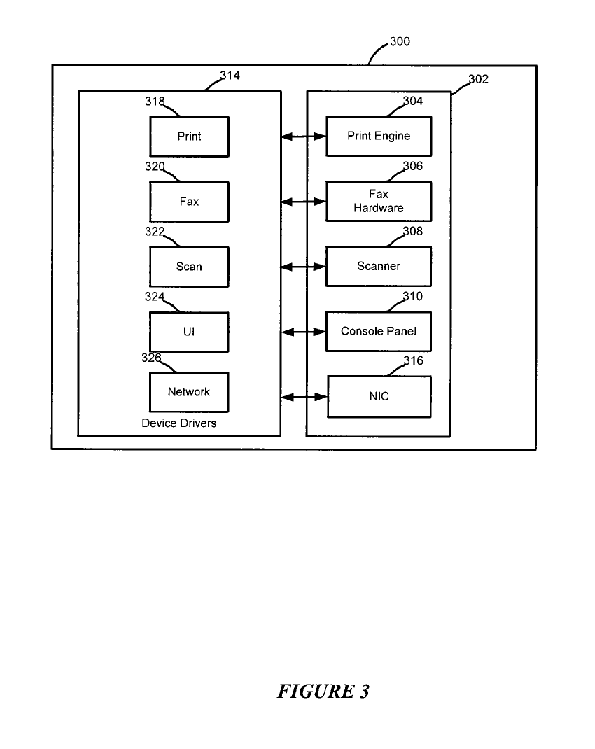

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

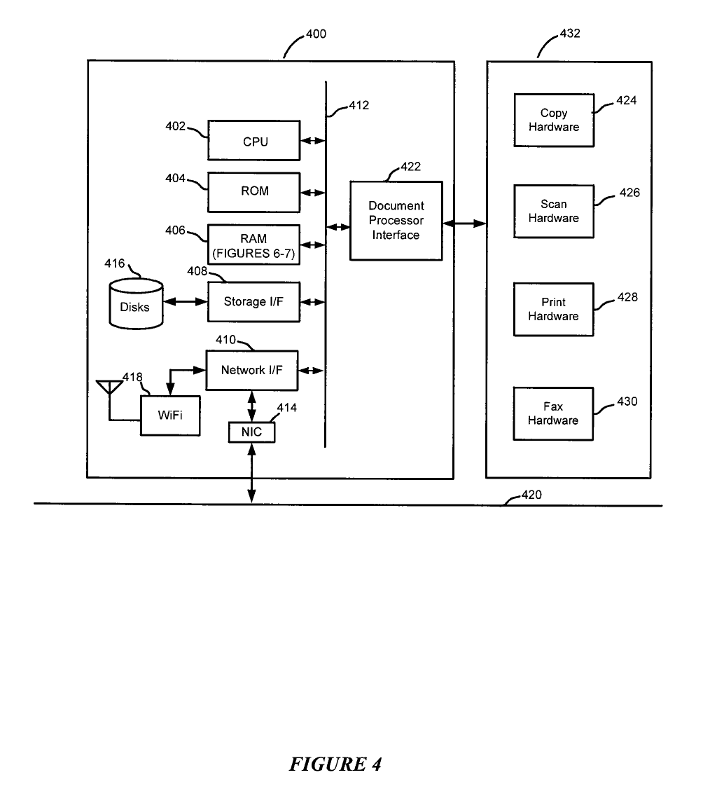

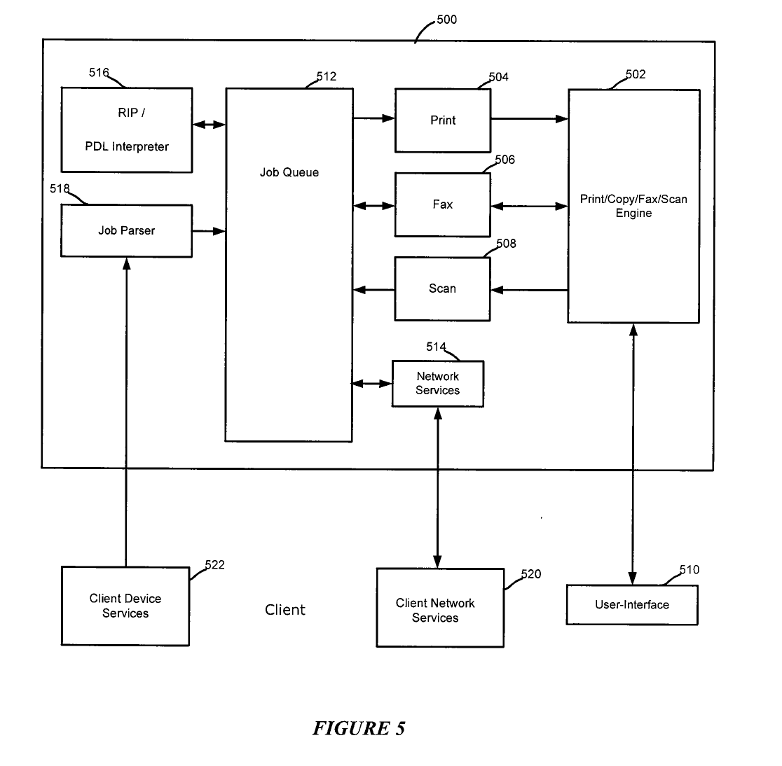

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the proof printing system and method for fee-based document output devices of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as an internal storage component of the associated document processing device 104, a component of the controller 108, or the like, such as, for example and without limitation, an internal hard disk drive, or the like. In accordance with one embodiment of the subject application, the data storage device 110 is capable of storing images, gift card formats, fonts, and the like.

Illustrated in FIG. 1 is a kiosk 114, communicatively coupled to the document processing device 104, and in effect, the computer network 102. It will be appreciated by those skilled in the art that the kiosk 114 is capable of being implemented as a separate component of the document processing device 104, or as an integral component thereof. Use of the kiosk 114 in FIG. 1 is for example purposes only, and the skilled artisan will appreciate that the subject application is capable of implementation without the use of kiosk. In accordance with one embodiment of the subject application, the kiosk 114 includes a display 116 and a user input device 118. As will be understood by those skilled in the art the kiosk 114 is capable of implementing a combination user input device/display, such as a touch screen interface. According to one embodiment of the subject application, the kiosk 114 is suitably adapted to display prompts to an associated user, receive instructions from the associated user, receive payment data, receive selection data from the associated user, and the like. Preferably, the kiosk 114 is suitably adapted to receive a portable storage media, such as a magnetic card, which includes transaction identification data. In accordance with such an embodiment, the kiosk 114 includes a magnetic card reader, conventional bar code reader, or the like, suitably adapted to receive and read payment data from a credit card, coupon, debit card, or the like.

The system 100 illustrated in FIG. 1 further depicts a user device 120, in data communication with the computer network 102 via a communications link 122. It will be appreciated by those skilled in the art that the user device 120 is shown in FIG. 1 as a laptop computer for illustration purposes only. As will be understood by those skilled in the art, the user device 120 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 120 is suitably adapted to generate and transmit electronic documents, document processing instructions, user interface modifications, upgrades, updates, personalization data, or the like, to the document processing device 104, or any other similar device coupled to the computer network 102. In accordance with one embodiment of the subject application, the user device 120 includes a web browser application, suitably adapted to securely interact with the document processing device 104, or the like. The skilled artisan will appreciate that the user device 120 is also capable of implementation as an administrative device, whereupon a user associated with the device 120 is able to access, delete, view, or otherwise modify data stored on the data storage device 110 associated with the document processing device 104.

Turning now to FIG. 2, illustrated is a representative architecture of a suitable device 200, (shown in FIG. 1 as the document processing device 104), on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, (shown in FIG. 1 as the document processing device 104), for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly, accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

In operation, electronic document data is first received corresponding to a selected electronic document for which a tangible output is desired. A user is then prompted for input of proof of output data representing an instruction to generate a single, tangible output copy corresponding to received electronic document data. Proof output instruction data is then received representing a desired sample tangible output corresponding to the received electronic document data. Output is then commenced of a single, tangible copy corresponding to the received electronic document data after the receipt of the proof of output instruction. Proof acceptability data is then received representing the acceptability of the single, tangible copy of the electronic document data. The receipt of proof output instruction data is then disabled upon=receipt of proof acceptability data corresponding to a disapproval of the single, tangible copy. Upon receipt of proof acceptability data corresponding to an approval of the single, tangible copy, fee data is generated associated with the generation of tangible output of the received electronic document data.

In accordance with one example embodiment of the subject application, a document processing request is received by the document processing device 104 via user interaction with the kiosk 114, the user interface 106, the user device 120, or the like. As the skilled artisan will appreciate, the document processing request includes, for example and without limitation, a requested document processing operation, such as a print or copy operation, to be performed on a given electronic document. Upon receipt of electronic document data, for example, an electronic document file from a portable storage media, network storage device, the user device 120, the result of a scanning operation, or the like, the user is prompted to select a number of copies, e.g., a number of output copies of the electronic document. According to one embodiment of the subject application, a graphical user interface corresponding to document processing operations associated with the document processing device 104 is first initiated via the user interface 106 associated with the document processing device 104, the display 116 of the kiosk 114, a thin client of the user device 120, or the like. Thus, the skilled artisan will appreciate that the prompting of the user is suitably accomplished via the graphical user interface.

The user is then prompted for proof output data, i.e., the user is prompted to select a proof printing operation whereupon a sample tangible output is to be printed prior to the completion of the output of all copies of the received document processing request. The skilled artisan will appreciate that such prompting is suitably accomplished via the graphical user interface displayed via the user interface 106, the display 116, the thin client of the user device 120, or the like. Upon a determination that no proof output is desired by the associated user, fee data is generated by the controller 108 or other suitable component of the document processing device 104 in association with the number of copies requested by the user. It will be appreciated by those skilled in the art that the generation of fee data is also capable of being based upon a plurality of varying factors associated with the cost of performing a requested document processing operation including, for example and without limitation, toner use, output media, colors, resolution, resource usage, and the like. The user is then prompted, via the graphical user interface, for payment in response to the generated fee data. In accordance with one embodiment of the subject application, payment is capable of being received in the form of credit card payment, cash, pre-paid account, debit card payment, billing account, or the like. Upon receipt of payment from the user in accordance with the generated fee data, the document processing device 104 performs the requested document processing operation and outputs the selected number of copies.

When the controller 108 or other suitable component associated with the document processing device 104 receives a proof output instruction from the user, indicia representing a proof output is generated for inclusion in a sample tangible output of a single copy of the electronic document data. Suitable examples of such indicia include, for example and without limitation, a watermark, a background, text, color, or the like, indicating the sample nature of the proof copy. Upon completion of the output of the single sample proof copy, the user is prompted, via the graphical user interface displayed on the user interface 106, the display 116, the thin client of the user device 120, or the like, for approval or disapproval of the proof copy. That is, whether or not the proof copy meets the requirements of the user with respect to resolution, colors, contrast, image quality, text quality, or a myriad of other subjective standards particular to the specific user. When approval is received from the user, the document processing device 104, via the controller 108 or kiosk 114, generates fee data associated with the output of the preselected number of copies of the electronic document data. The fee data is displayed to the user via the associated user interface 106, the display 116, the thin client interface of the user device 120, or the like, which prompts the user for payment. Upon receipt of payment, the document processing device 104 outputs the preselected number of copies of the electronic document data.

When the user does not approve of the proof copy of the electronic document data, the receipt of proof output instruction data is disabled and the user is prompted to revise the electronic document data. The skilled artisan will appreciate that the user is unable to continue to output proof copies, thereby preventing the user from outputting multiple copies of the electronic document data without incurring any charges. Upon receipt of revised electronic document data, the controller 108 or other suitable component associated with the document processing device 104 re-enables the ability to receive proof output instruction data. Operations then return to prompting the user to input proof output data, i.e., instructions to output a proof copy of the revised electronic document data. Thereafter, operations continue as set forth above until the user is satisfied with the proof copy and approves the sample output represented by the proof copy. The user then supplies payment in accordance with generated feed data and the preselected number of copies are then output by the document processing device 104.

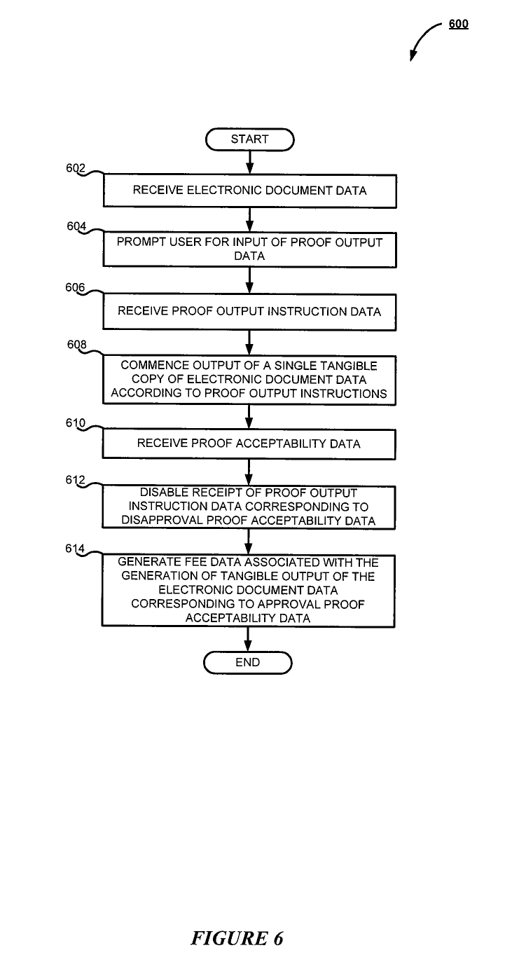

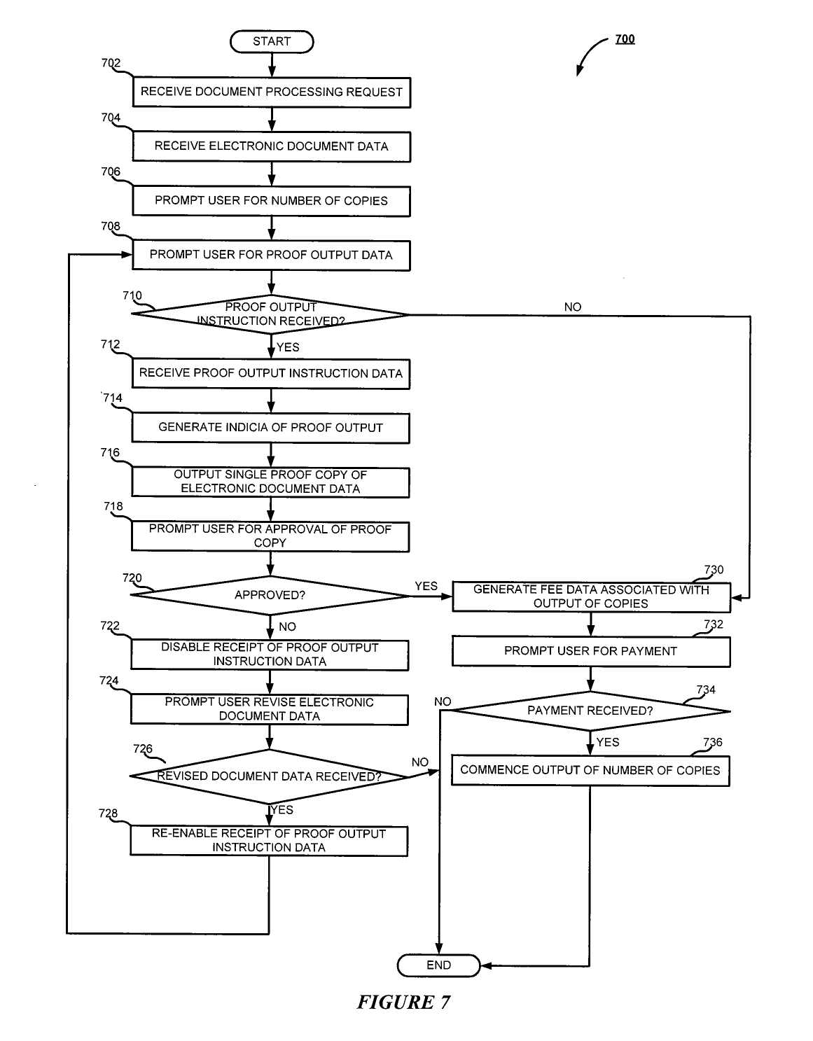

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a print proofing method for fee-based document output devices in accordance with one embodiment of the subject application. Beginning at step 602, electronic document data is received by a document processing device 104 corresponding to an electronic document for which a user desires a tangible output. The user is then prompted, at step 604, for input of proof output data. In accordance with one embodiment of the subject application, the proof output data represents an instruction to generate a single, tangible sample output copy of the received electronic document data. Proof output instruction data is then received from the user by the controller 108 or other suitable component associated with the document processing device 104 at step 606. Preferably, the prompting and receipt of proof instructions is accomplished via a suitable graphical user interface, generated via the user interface 106, the display 116, a thin client operative on the user device 120, or the like.

At step 608, the document processing device 104, via direction of the controller 108, commences the output of a single tangible sample copy of the electronic document represented by the received electronic document data. Proof acceptability data is then received at step 610 representing an acceptability of the single, tangible copy. In accordance with one embodiment of the subject application, the proof acceptability data is received by the controller 108 or other suitable component of the document processing device 104 via the graphical user interface of the user interface 106, the display 116, the thin client of the user device 120, or the like. At step 612, receipt of proof output instruction data is disabled in accordance with received proof acceptability data corresponding to a disapproval of the single, tangible copy. That is, upon user disapproval of the sample copy, the proof output instruction data is disabled. The skilled artisan with therefore appreciate that the user is provided with a single opportunity to output a proof copy, thereby preventing the free printing of multiple copies of a document. At step 614, fee data is generated in association with the generation of tangible output of the electronic document data upon receipt of proof acceptability data corresponding to an approval of the single, tangible copy.

Referring now to FIG. 7, there is shown a flowchart 700 illustrating print proofing method for fee-based document output devices in accordance with one embodiment of the subject application. The example embodiment depicted in FIG. 7 begins at step 702, whereupon a document processing request, representative of a desired document output operation, is received from an associated user via the user interface 106, the kiosk 114, a thin client of the user device 120, or the like. Preferably, the associated user interacts with the document processing device 104 via a suitable graphical user interface, displayed via the user interface 106, the display 116 of the kiosk 114, the thin client of the user device 120, or the like. At step 704, electronic document data corresponding to a selected electronic document for which a tangible output is desired is received from the associated user. As will be appreciated by those skilled in the art, the electronic document data is capable of being received from a portable storage media, a network storage device, the user device 120, generated via a scanning operation of the document processing device 104, received via electronic mail, or the like.

The user is then prompted, at step 706, to select a number of copies, i.e., a number of tangible outputs of the received electronic document data. The user is then prompted, via the graphical user interface for proof output data at step 708. That is, the user is prompted to output a single sample hardcopy, or proof, of the electronic document corresponding to the received electronic document data. A determination is then made at step 710 whether the user has provided proof output instruction data corresponding to the generation of a single, tangible output of the electronic document. When the user has elected not to output a proof copy, flow proceeds to step 730, discussed in greater detail below. When the user has elected to output a proof copy, flow proceeds to step 712, whereupon proof output instruction data is received by the controller 108 or other suitable component associated with the document processing device 104. At step 714, indicia corresponding to the proof output is generated by the controller 108 or other suitable component of the document processing device 104, which indicates that the single, tangible output to be generated by the document processing device 104 as a proof copy is indeed a proof copy. That is, a watermark, background image, foreground image, text indicator, graphical indicator, or the like, is generated denoting that the hardcopy output by the document processing device 104 is a proof copy of the electronic document data.

At step 716, the document processing device 104 outputs a single proof copy of the electronic document data. It will be appreciated by those skilled in the art that the single proof copy so generated by the document processing device 104 includes the electronic document data, as well as the indicia of proof output generated by the controller 108 or other suitable component of the document processing device 104. The user is then prompted, at step 718, for approval of the proof copy. Flow then progresses to step 720, whereupon a determination is made whether the user has approved the proof copy. That is, whether or not the proof copy is acceptable to the user.

Upon a determination at step 720 that the user does not approve of the proof copy, flow proceeds to step 722, whereupon the receipt of proof output data is disabled. Stated another way, at step 722, the user is prevented from selecting the print proof copy, thus restricting the user to a single tangible output of a proof copy of the originally received electronic document data. The user is then prompted, at step 724, to revise the electronic document data. That is, the user is prompted to alter, modify, or otherwise change the electronic document data, in essence to start over, thus facilitating the prevention of the user from outputting multiple copies of the proof copy. A determination is then made at step 726 whether revised electronic document data has been received from the user. When no revised electronic document data is detected, the operation terminates. When revised electronic document data has been received by the document processing device 104 at step 726, flow proceeds to step 728, whereupon the ability to output a proof copy is re-enabled. That is, the receipt of proof output instruction data is re-enabled. Flow then returns to step 708, prompting the user for proof output data.

Returning to step 720, when the proof copy is approved by the user, i.e., the representative sample of the proof copy is acceptable to the user, flow proceeds to step 730. At step 730, the controller 108 or other suitable component of the document processing device 104 generates fee data associated with the output of the electronic document data in accordance with the selected number of copies. It will be appreciated by those skilled in the art that the determination of the costs associated with outputting the requested number of hardcopies of the electronic document is based upon, for example and without limitation, the number of copies, the number of pages of each copy, toner usage, number of colors, resolution, resource usage, and the like. The user is then prompted, via the graphical user interface displayed on the user interface 106, the display 116, or the thin client of the user device 120, for payment of the generated fee at step 732. In accordance with one embodiment of the subject application, the user is capable of providing payment via any known means, including, for example and without limitation, credit card, debit card, pre-paid account, coupon, billing account, cash, or the like. A determination is then made at step 734 whether payment has been received. When payment has not been received, the operation terminates. When payment has been received, the document processing device 104, at step 736, outputs the selected number of copies of the electronic document in tangible output form.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A print proofing system for fee-based document output devices comprising:
means adapted for receiving electronic document data representative of a selected electronic document for which a tangible output is desired;
means adapted for prompting a user for input of proof output data representative of an instruction to generate a single, tangible output copy corresponding to received electronic document data;
means adapted for receiving proof output instruction data representative of a desired sample tangible output corresponding to received electronic document data;
means adapted for commencing output of a single, tangible copy corresponding to received electronic document data after receipt of a proof output instruction;
means adapted for receiving proof acceptability data representative of acceptability of the single, tangible copy;
means adapted for disabling receipt of proof output instruction data in accordance with received proof acceptability data corresponding to disapproval of the single, tangible copy; and
fee generation means adapted for generating fee data associated with generation of tangible output corresponding to the electronic document data upon receipt of proof output acceptability data corresponding to approval of the single, tangible copy.

2. The print proofing system of claim 1 further comprising:
means adapted for receiving revised electronic document data after receipt of proof acceptability data corresponding to disapproval; and
means adapted for re-enabling receipt of proof output instruction data after receipt of revised electronic document data.

3. The print proofing system of claim 1 further comprising means adapted for generating an indicia corresponding to a proof output operation on the single, tangible output copy.

4. The print proofing system of claim 1 further comprising:
means adapted for receiving count data corresponding to a number of desired tangible output copies associated with electronic document data; and
means adapted for commencing output of a number of tangible output copies in accordance with received count data.

5. The print proofing system of claim 4 wherein the fee generation means includes means adapted for generating fee data in accordance with received count data.

6. The print proofing system of claim 5 further comprising means adapted for receiving payment data from the associated user, which payment data corresponds to generated fee data.

7. A print proofing method for fee-based document output devices comprising the steps of:
receiving electronic document data representative of a selected electronic document for which a tangible output is desired;
prompting a user for input of proof output data representative of an instruction to generate a single, tangible output copy corresponding to received electronic document data;
receiving proof output instruction data representative of a desired sample tangible output corresponding to received electronic document data;
commencing output of a single, tangible copy corresponding to received electronic document data after receipt of a proof output instruction;
receiving proof acceptability data representative of acceptability of the single, tangible copy;
disabling receipt of proof output instruction data in accordance with received proof acceptability data corresponding to disapproval of the single, tangible copy; and
generating fee data associated with generation of tangible output corresponding to the electronic document data upon receipt of proof output acceptability data corresponding to approval of the single, tangible copy.

8. The print proofing method of claim 7 further comprising the steps of:
receiving revised electronic document data after receipt of proof acceptability data corresponding to disapproval; and
re-enabling receipt of proof output instruction data after receipt of revised electronic document data.

9. The print proofing method of claim 7 further comprising the step of generating an indicia corresponding to a proof output operation on the single, tangible output copy.

10. The print proofing method of claim 7 further comprising the steps of:
receiving count data corresponding to a number of desired tangible output copies associated with electronic document data; and
commencing output of a number of tangible output copies in accordance with received count data.

11. The print proofing method of claim 10 wherein the step of generating fee data is in accordance with received count data.

12. The print proofing method of claim 11 further comprising the step of receiving payment data from the associated user, which payment data corresponds to generated fee data.

13. A computer-implemented method for print proofing for fee-based document output devices comprising the steps of:
receiving electronic document data representative of a selected electronic document for which a tangible output is desired;
prompting a user for input of proof output data representative of an instruction to generate a single, tangible output copy corresponding to received electronic document data;
receiving proof output instruction data representative of a desired sample tangible output corresponding to received electronic document data;
commencing output of a single, tangible copy corresponding to received electronic document data after receipt of a proof output instruction;
receiving proof acceptability data representative of acceptability of the single, tangible copy;
disabling receipt of proof output instruction data in accordance with received proof acceptability data corresponding to disapproval of the single, tangible copy; and
generating fee data associated with generation of tangible output corresponding to the electronic document data upon receipt of proof output acceptability data corresponding to approval of the single, tangible copy.

14. The computer-implemented method of claim 13 further comprising the steps of:
receiving revised electronic document data after receipt of proof acceptability data corresponding to disapproval; and
re-enabling receipt of proof output instruction data after receipt of revised electronic document data.

15. The computer-implemented method of claim 13 further comprising the step of generating an indicia corresponding to a proof output operation on the single, tangible output copy.

16. The computer-implemented method of claim 13 further comprising the steps of:
receiving count data corresponding to a number of desired tangible output copies associated with electronic document data; and
commencing output of a number of tangible output copies in accordance with received count data.

17. The computer-implemented method of claim 16 wherein the step of generating fee data is in accordance with received count data.

18. The computer-implemented method of claim 17 further comprising the step of receiving payment data from the associated user, which payment data corresponds to generated fee data.
